(19) United States
(12) Patent Application Publication
(10) Pub. No.: US 2007/0035660 A1
(43) Pub. Date: Feb. 15, 2007

(54) VIDEO PROCESSING METHOD CAPABLE OF PREVENTING ROUGH MOVEMENT OF VIDEO OBJECT, AND RELATED DEVICE

(76) Inventor: Jin-Sheng Gong, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/460,253

(22) Filed: Jul. 27, 2006

(30) Foreign Application Priority Data
Aug. 12, 2005 (TW) 094127529

(51) Int. Cl. H04N 11/20

(52) U.S. Cl. 348/448

(57) ABSTRACT

A video processing method includes: reading a video signal including a plurality of first fields and a plurality of second fields, where the number of the first fields is different from the number of the second fields; and processing the plurality of first fields of the video signal and/or the plurality of second fields of the video signal to generate a plurality of first pictures and a plurality of second pictures, where the number of the first pictures is equal to the number of the second pictures.

### BACKGROUND OF THE INVENTION

1. Field of the Invention

The present invention relates to Telecine processing, and more particularly, to video processing methods capable of preventing rough movements of video objects, and related devices.

2. Description of the Prior Art

Movies are typically made and played at a speed of 24 frames per second. If a movie need to be played by a video playback device such as a television or a digital versatile disc (DVD) player, the video frames of the movie can be converted into video data of National Television System Committee (NTSC) format or Phase Alternating Line (PAL) format by utilizing Telecine processing.

3:2 pull-down processing is a typical processing method of the Telecine processing mentioned above. Please refer to FIG. 1. After performing the 3:2 pull-down processing, a received video signal carrying the video frames of the movie is converted into NTSC format to generate interlace fields of 60 Hz, as shown in FIG. 1. If a portion of the original video frames of the movie is illustrated by utilizing a sequence {A, B, C, D} with A, B, C, and D of the sequence {A, B, C, D} respectively representing the contents of the video frames of the movie, a series of fields generated after performing the 3:2 pull-down processing can be represented by utilizing a sequence {A, A, A, B, B, C, C, C, D, D}, where the fields comprises even fields and odd fields. According to FIG. 1, within the same time interval for playing the contents A, B, C, and D of the original video frames of the movie, the contents A, B, C, and D of the odd or even fields are respectively played three times, two times, three times, and two times, meaning that after the 3:2 pull-down processing mentioned above, the contents A, B, C, and D are eventually displayed at varied display time points rather than the original display time points for playing the contents A, B, C, and D of the original video frames of the movie. Therefore, regarding a displayed video object moving around, rough movements of the video object lead to unfaithful playback.

A conventional method attempting to solve the problem of rough movements of the video object according to the prior art is performing motion interpolation along the time axis, meaning that performing interpolation along the time axis to generate new images. For example, regarding a partial sequence {A, A, A, B, B} of the odd/even fields mentioned above, along the time axis, first cut the time interval corresponding to the contents A and B into five segments, and then perform interpolation on the contents A and B along the time axis to make each video object moving smoothly. Although this method may maintain the original refresh rate of 60 Hz, the calculation, cutting, and reconstruction along the time axis lead to heavy load of a software application program or hardware device implemented by utilizing this method. In addition, if a calculation error occurs, the coming display results may have an erroneous moving trace or an erroneous image.

### SUMMARY OF THE INVENTION

It is an objective of the claimed invention to provide video processing methods and devices that are capable of preventing rough movements of video objects, in order to achieve best image quality.

According to one embodiment of the claimed invention, a video processing method is disclosed. The video processing method comprises the following steps: reading a video signal comprising a plurality of first fields and a plurality of second fields, where the number of the first fields is different from the number of the second fields; and processing the plurality of first fields of the video signal and/or the plurality of second fields of the video signal to generate a plurality of first pictures and a plurality of second pictures, where the number of the first pictures is substantially equal to the number of the second pictures, and the plurality of first pictures correspond to the plurality of first fields and the plurality of second pictures correspond to the plurality of second fields.

According to one embodiment of the claimed invention, a video processing device is further disclosed. The video processing device comprises: a buffer comprising a plurality of buffering areas, where the plurality of buffering areas are utilized for storing an input video signal corresponding to a first refresh rate, the input video signal comprises a plurality of first fields and a plurality of second fields, and the number of the first fields is different from the number of the second fields; a buffering control circuit, coupled to the buffer, the buffering control circuit reading the fields from the buffering areas to generate an output video signal corresponding to a second refresh rate, where the output video signal comprises a plurality of first pictures and a plurality of second pictures, and the number of the first pictures is substantially equal to the number of the second pictures; and a frequency control circuit, coupled to the buffering control circuit, for controlling the ratio of the second refresh rate to the first refresh rate, where the ratio of the second refresh rate to the first refresh rate is equal to a first predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of 3:2 pull-down processing and the corresponding displayed pictures according to the prior art.

FIG. 2 illustrates a video processing method for generating pictures while performing de-interlacing processing on a plurality of fields according to one embodiment of the present invention.

FIG. 3 is a diagram of a video processing device of the embodiment shown in FIG. 2.

FIG. 4 illustrates a video processing method for generating pictures while performing de-interlacing processing on a plurality of fields according to one embodiment of the present invention.

FIG. 5 is a diagram of a video processing device of the embodiment shown in FIG. 4.

### DETAILED DESCRIPTION

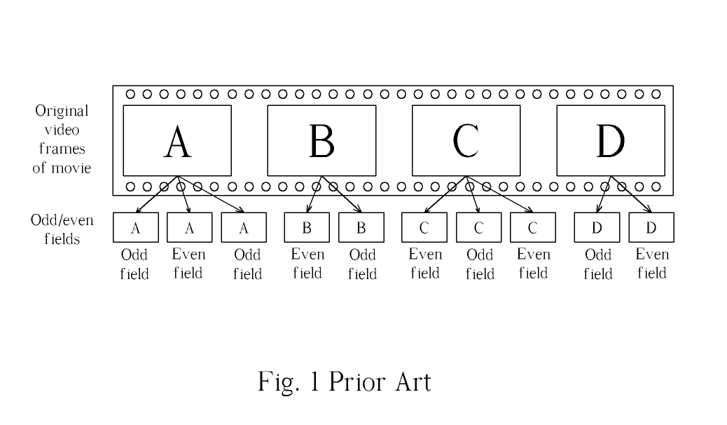

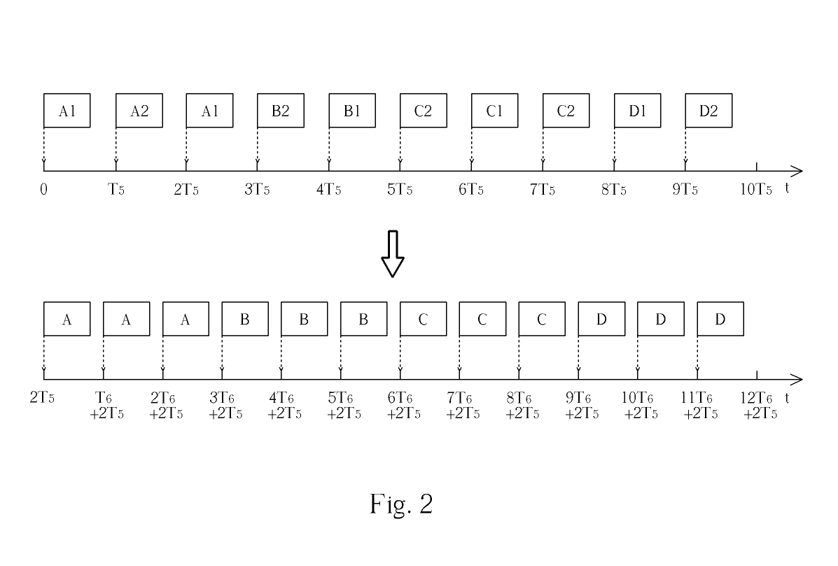

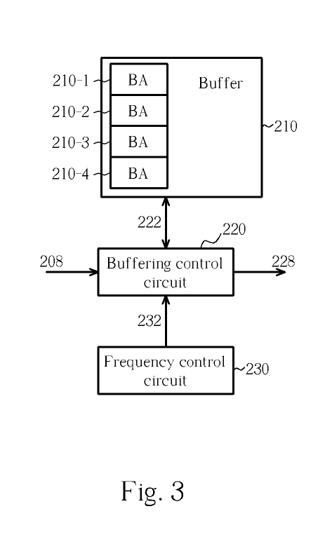

Please refer to FIG. 2 and FIG. 3. FIG. 2 illustrates a video processing method for generating pictures while performing de-interlacing on a plurality of fields according to one embodiment of the present invention, where FIG. 3 is a diagram of a video processing device of the embodiment shown in FIG. 2. The interlaced fields with refresh rate f₁ equal to 60 Hz is generated by performing the 3:2 pull-down processing shown in FIG. 1 and carried by a video signal 208. As mentioned above, the fields comprise a series of odd/even fields, which can be represented by utilizing a sequence {A1, A2, A1, B2, B1, C2, C1, C2, D1, D2}. Here, A1, B1, C1, and D1 represent odd fields, and A2, B2, C2, and D2 represent even fields. Within the video processing device shown in FIG. 3, a buffering control circuit 220 is capable of temporarily storing the odd/even fields in specific buffering areas in a buffer 210. The buffering control circuit 220 is capable of reading the contents that are temporarily stored (i.e., the fields) from the buffering areas and performing the de-interlacing to generate another video signal 228 corresponding to another refresh rate f₂. As shown in FIG. 2, the pictures generated by performing the de-interlacing processing can be represented by utilizing a new sequence {A, A, A, B, B, B, C, C, C, D, D, D}, where these pictures are carried by the video signal 228 and correspond to the refresh rate f₂.

A frequency control circuit 230 of the video processing device shown in FIG. 3 is capable of controlling the ratio of the refresh rate f₂ to the refresh rate f₁, where the ratio can be equal to a first predetermined value. In this embodiment, as the refresh rate f₁ is equal to 60 Hz and the refresh rate f₂ is equal to 72 Hz, the ratio of the refresh rate f₂ to the refresh rate f₁ is equal to 6/5 accordingly. That is, the first predetermined value is equal to 6/5. The refresh rate f₁ is a reciprocal of the refresh period T₅ shown in FIG. 2, and the refresh rate f₂ is a reciprocal of the refresh period T₆ shown in FIG. 2. According to this embodiment, the pictures generated by performing the de-interlacing processing is outputted by utilizing the refresh rate f₂ and represented by the sequence {A, A, A, B, B, B, C, C, C, D, D, D}. During the de-interlacing processing shown in FIG. 2, an additional picture B (a picture of the content B) and an additional picture D (a picture of the content D) are newly generated, whereby the number of pictures A is substantially equal to the number of pictures B, and the number of pictures C is substantially equal to the number of pictures D, where the rest may be deduced by analogy. As a result, each video object displayed by utilizing the pictures moves smoothly, and the problem of rough movements is solved.

In addition, the frequency control circuit 230 of this embodiment is capable of switching the ratio of the refresh rate f₂ to the refresh rate f₁ between the first predetermined value and a second predetermined value (e.g., 4/5) when needed.

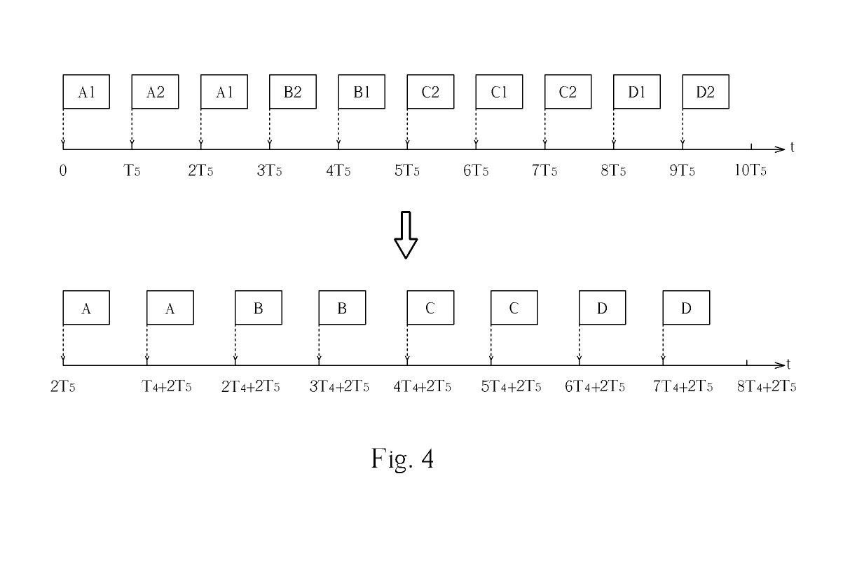

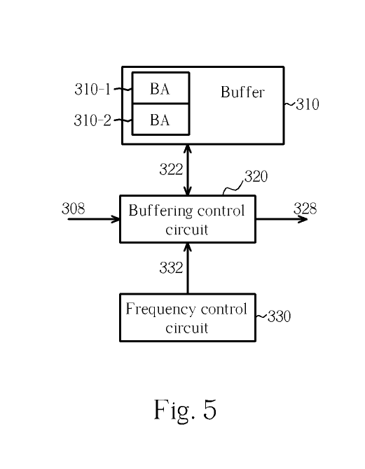

Please refer to FIG. 4 and FIG. 5. FIG. 4 illustrates a video processing method generating pictures while performing de-interlacing on a plurality of fields according to another embodiment of the present invention, where FIG. 5 is a diagram of a video processing device of the embodiment shown in FIG. 4. The interlaced fields with refresh rate f₁ equal to 60 Hz is generated by performing the 3:2 pull-down processing shown in FIG. 1 and carried by a video signal 308. As mentioned above, these fields can be represented by utilizing the sequence {A1, A2, A1, B2, B1, C2, C1, C2, D1, D2}. Within the video processing device shown in FIG. 5, a buffering control circuit 320 is capable of temporarily storing the odd/even fields in specific buffering areas in a buffer 310. The buffering control circuit 320 is capable of reading the contents that are temporarily stored (i.e., the fields) from the buffering areas and performing the de-interlacing to generate another video signal 328 corresponding to another refresh rate f₃. As shown in FIG. 4, the pictures generated by performing the de-interlacing can be represented by utilizing a new sequence {A, A, B, B, C, C, D, D}, where these pictures are carried by the video signal 328 and correspond to the refresh rate f₂.

A frequency control circuit 330 of the video processing device shown in FIG. 5 is capable of controlling the ratio of the refresh rate f₃ to the refresh rate f₁, where the ratio can be equal to a predetermined value. According to this embodiment, as the refresh rate f₁ is equal to 60 Hz and the refresh rate f₃ is equal to 48 Hz, the ratio of the refresh rate f₃ to the refresh rate f₁ is equal to 4/5 accordingly. The refresh rate f₁ is a reciprocal of the refresh period T₅ shown in FIG. 4, and the refresh rate f₃ is a reciprocal of the refresh period T₄ shown in FIG. 4. According to this embodiment, the pictures generated by performing the de-interlacing is outputted by utilizing the refresh rate f₃ and represented by the sequence {A, A, B, B, C, C, D, D}. During the de-interlacing processing shown in FIG. 4, a redundant picture A (a picture of the content A) and a redundant picture C (a picture of the content C) are discarded, whereby the number of pictures A is substantially equal to the number of pictures B, and the number of pictures C is substantially equal to the number of pictures D, where the rest may be deduced by analogy. As a result, each video object displayed by utilizing the pictures moves smoothly, and the problem of rough movements is solved.

It is noted that in general, display devices that are typically utilized as monitors may have an upper bond of the refresh rate tolerance up to 75 Hz, so any of the video processing methods shown in FIG. 2 and FIG. 4 can be applied to these display devices. Regarding televisions, they may have an upper bond of the refresh rate tolerance up to 63 Hz and an lower bond of the refresh rate tolerance around 47 Hz, so the video processing method shown in FIG. 4 can be applied to the televisions, i.e., converting the refresh rate into 48 Hz is a gradual implementation method, which is steadier, in contrast to converting the refresh rate into 72 Hz.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing method, comprising the following steps:
reading a video signal comprising a plurality of first fields and a plurality of second fields, wherein the number of the first fields is different from the number of the second fields; and
processing the plurality of first fields and/or the plurality of second fields to generate a plurality of first pictures and a plurality of second pictures, wherein the number of the first pictures is substantially equal to the number of the second pictures, and the plurality of first pictures correspond to the plurality of first fields and the plurality of second pictures correspond to the plurality of second fields.

2. The video processing method of claim 1, wherein the step of processing the plurality of first fields and/or the plurality of second fields further comprises:
performing de-interlacing.

3. The video processing method of claim 2, further comprising:
when the number of the first pictures is greater than the number of the second pictures, discarding a portion of the plurality of first pictures.

4. The video processing method of claim 2, further comprising:
when the number of the first pictures is less than the number of the second pictures, increasing the number of the first pictures.

5. The video processing method of claim 1, further comprising:
when the number of the first fields is greater than the number of the second fields, discarding a portion of the plurality of the first fields.

6. The video processing method of claim 1, further comprising:
when the number of the first fields is less than the number of the second fields, increasing the number of the first fields.

7. The video processing method of claim 1, further comprising:
outputting the adjusted video signal according to a second refresh rate.

8. The video processing method of claim 7, wherein the step of reading the video signal further comprises:
reading the video signal in accordance with a first refresh rate.

9. The video processing method of claim 8, wherein the ratio of the second refresh rate to the first refresh rate complies with a predetermined ratio.

10. A video processing device, comprising:
a buffer comprising a plurality of buffering areas, wherein the plurality of buffering areas are utilized for storing an input video signal corresponding to a first refresh rate, the input video signal comprises a plurality of first fields and a plurality of second fields, and the number of the first fields is different from the number of the second fields;
a buffering control circuit, coupled to the buffer, the buffering control circuit reading the fields from the buffering areas to generate an output video signal corresponding to a second refresh rate, wherein the output video signal comprises a plurality of first pictures and a plurality of second pictures, and the number of the first pictures is substantially equal to the number of the second pictures; and
a frequency control circuit, coupled to the buffering control circuit, for controlling the ratio of the second refresh rate to the first refresh rate, wherein the ratio of the second refresh rate to the first refresh rate is equal to a first predetermined value.

11. The video processing device of claim 10, wherein the frequency control circuit switches the ratio of the second refresh rate to the first refresh rate to a second predetermined value.

12. The video processing device of claim 10, wherein the ratio of the second refresh rate to the first refresh rate is approximately equal to 6/5.

13. The video processing device of claim 10, wherein the ratio of the second refresh rate to the first refresh rate is approximately equal to 4/5.

14. A video processing method, comprising:
reading an input video signal comprising a plurality of first fields and a plurality of second fields, wherein the number of the first fields is different from the number of the second fields; and
outputting an output video signal according to the input video signal, the output video signal comprising a plurality of first pictures and a plurality of second pictures, wherein the number of the first pictures is substantially equal to the number of the second pictures.

15. The video processing method of claim 14, wherein the plurality of first pictures correspond to the plurality of first fields, and the plurality of second pictures correspond to the plurality of second fields.

16. The video processing method of claim 15, wherein the outputting step further comprises:
when the number of the first fields is greater than the number of the second fields, discarding a portion of the plurality of first fields, whereby the number of the first pictures is substantially equal to the number of the second pictures.

17. The video processing method of claim 15, wherein the outputting step further comprises:
when the number of the first fields is less than the number of the second fields, increasing the number of the first fields, whereby the number of the first pictures is substantially equal to the number of the second pictures.

18. The video processing method of claim 15, wherein the outputting step further comprises:
when the number of the first fields is greater than the number of the second fields, discarding a portion of the plurality of first pictures, whereby the number of the first pictures is substantially equal to the number of the second pictures.

19. The video processing method of claim 15, wherein the outputting step further comprises:
when the number of the first fields is less than the number of the second fields, increasing the number of the first pictures, whereby the number of the first pictures is substantially equal to the number of the second pictures.

20. The video processing method of claim 15, wherein the reading step further comprises reading the input video signal according to a first refresh rate, and the outputting step further comprises outputting the output video signal according to a second refresh rate, and the ratio of the second refresh rate to the first refresh rate complies with a predetermined ratio.

21. The video processing method of claim 20, wherein the ratio of the second refresh rate to the first refresh rate is approximately equal to 6/5.

22. The video processing method of claim 20, wherein the ratio of the second refresh rate to the first refresh rate is approximately equal to 4/5.
